(19) United States
(12) Patent Application Publication
(10) Pub. No.: US 2003/0054885 A1
(43) Pub. Date: Mar. 20, 2003

(54) Electronic community for trading information about fantasy sports leagues

(76) Inventors: Albert Gregory Pinto, Anaheim Hills, CA (US); Malachi Daniel Clark, Costa Mesa, CA (US)

Correspondence Address: STETINA BRUNDA GARRED & BRUCKER, 75 ENTERPRISE, SUITE 250, ALISO VIEJO, CA, 92656, US

(21) Appl. No.: 09/953,794

(22) Filed: Sep. 17, 2001

(51) Int. Cl. G06F 17/00

(52) U.S. Cl. 463/42

(57) ABSTRACT

A system and method for creating an electronic community for trading information about fantasy sports leagues is disclosed. The system and method allow users to become members of the community. Members of the community can communicate with each other. Members of the community can also each create their own personalized fantasy sports team based on available electronic trading cards for players. Players receive statistics for their team. Players can trade players on their team for new players.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present invention relates generally to electronic communications, and more particularly to a system and method for a group of people (community) to electronically trade information about a specific topic, specifically fantasy sports league information.

Sports enthusiasts know that they could do a better job of managing a sports team than the actual owners/managers/coaches. Fantasy sports leagues provide sports enthusiast an opportunity to do just that—to manage a sports team. There are many fantasy sports leagues for various sports, e.g., football, baseball, auto racing, soccer, etc.

Many of the fantasy sports leagues are small, informal leagues with participants who are all in geographic proximity. For example, a group of twenty participants may meet in person preseason to pick their fantasy teams. In such teams, any one player can only be a member of one team. Such leagues may use a draft pick process to select team members. Small fantasy leagues typically have an administrator that obtains sports statistics on a periodic basis, e.g., every Tuesday for professional football. The administrator then uses the statistics of the players for each fantasy team to determine the score for the fantasy team. Various leagues have different methods for determining team scores. For example, point values are assigned for various events, such as passes, rushes, receiving, kicking, defensive plays, etc. The points for each of the events are tallied to determine a score for the fantasy team. In exemplary leagues, the fantasy teams compete head-to-head with other fantasy teams on the league according to a schedule created prior to the season. Such leagues may allow players to be traded during the season. Trading of players typically requires processing through the league administrator. The participants may have multiple players for a given position. In such cases, the participant typically notifies the administrator within a specified period of time prior to a game which player will be used in a particular position for a particular game. Such leagues take a great deal of time and effort on both the part of the participants and the administrator. Furthermore, the only feedback or interaction that participants have about their team is that they are provided with a score of how their team did along with a list of scores of the other league participants.

There are also many online fantasy sports leagues that help to alleviate some of the problems described above. Like the manual fantasy sports leagues, the online fantasy sports leagues typically have an administrator. Online leagues may be small leagues, such as the manual leagues described above. Online leagues may also be on a larger scale. The fantasy leagues that are on a larger scale typically do not limit the number of teams on which a given player may be a member. The results returned in such leagues are similar to those returned in the manual fantasy sports leagues. A participant receives a score which may also include a breakdown of how the total score was calculated.

While traditional fantasy sports leagues provide entertainment for sports enthusiasts, they are very time consuming. Furthermore, the results do not provide an interactive or visual experience that enhances the enthusiasts interest in the particular sport. Therefore, a need exists for a fantasy sports league that more efficiently determines and disseminates fantasy sports scores. Furthermore, the fantasy sports league should include interactions which enhance the participants sports experience, for example, by automatically downloading audio and or video highlights of the participant's team players to the participants computer. The participant should be able to store the downloaded information, as well as transmit it to other league participants.

### BRIEF SUMMARY OF THE INVENTION

The present invention provides a system and method to create a fantasy sports card community having a plurality of fantasy sports card community members, each of the community members being able to create a personalized fantasy sports team having a plurality of players, change the sports team by trading players, obtain statistics for the players on the sports team and communicate with other fantasy sports card community members. The system includes a server and a plurality of member computers. A method is implemented by the server for: a) creating a plurality of electronic trading cards, each of the electronic trading cards identifying a player and including statistical information about the player stored thereon; b)creating a fantasy sports league database by storing the identity and statistical information corresponding to each of the players identified on the electronic trading cards; c) registering the community members; d)generating a list of available players from the electronic trading cards; e) transmitting the list of available players to at least one of the community members to facilitate the creation of the personalized fantasy sports team; f) receiving a list of selected players from at least one of the fantasy sports card community members; g) creating the personalized fantasy sports team for at least one of the community members based on the list of selected players; and h) transmitting the electronic trading cards corresponding to the list of selected players to at least one of the community members.

In accordance with other aspects of the invention, steps (d)-(h) are repeated for each of the community members registered in step (c).

In accordance with yet other aspects of the invention, step (a) comprises: i) determining a number of personalized fantasy sports teams on which each player can be a participant; and ii) creating a volume of each electronic trading card corresponding to the number of personalized fantasy sports teams on which each player can be a participant.

In accordance with still other aspects of the invention, the method further comprises the steps of: i) calculating statistics for the personalized fantasy sports team based on the statistical information stored on the electronic trading cards corresponding to the participants on the personalized fantasy sports team; and j) transmitting the statistics for the personalized fantasy sports team to at least one of the member computers.

In accordance with yet other aspects of the invention, the method further comprising the steps of: i) changing the personalized fantasy sports team by replacing at least one player on the personalized fantasy sports team with at least one different player; j) transmitting a delete command including instructions for deleting the electronic trading cards corresponding to the at least one player on the personalized fantasy sports team that is being replaced; and k) transmitting the electronic trading card corresponding to at least one different player replacing at least one player being deleted to at least one of the member computers. The method may also further comprise: l) calculating statistics for the changed personalized fantasy sports team based on the statistical information stored on the electronic trading cards corresponding to the changed personalized fantasy sports team; and m) transmitting the statistics for the changed personalized fantasy sports team. Step (i) may comprise selecting the at least one different player from at least one other fantasy sports card community member.

In accordance with further aspects of the invention, a method is implemented on the member computers for: a) registering the user as one of the fantasy sports card community members through the use of at least one of the member computers; b) receiving a list of available players from the server; c) creating a list of selected players from the list of available players; d) transmitting the list of selected players to the server for creating the personalized fantasy sports team; e) receiving electronic trading cards corresponding to the list of selected players, each of the electronic trading cards identifying a player and including statistical information corresponding to the identified player; and f) storing the electronic trading cards on at least one of the member computers.

In accordance with yet further aspects of the invention, the method further comprises the step of: (g) receiving statistics for the personalized fantasy sports team based on the statistical information stored on the corresponding electronic trading cards. The method may also further comprise the steps of: g) displaying a communication interface on the member computer to allow a first fantasy sports card community member to interactively communicate with at least one other fantasy sports card community member; h) accepting information from the first fantasy sports card community member via the communication interface; and i) forwarding the information from the first fantasy sports card community member to the at least one other fantasy sports card community member. Step (g) may comprise displaying a white board as the communication interface.

In accordance with further aspects of the invention, steps (a)-(f)are implemented through the use of a browser. Preferably, the browser is a category specific mini browser.

In accordance with yet further aspects of the invention, the method may further comprise the step of: (g) receiving updated statistics for each player identified on the electronic trading cards stored on the at least one of the member computers.

In accordance with still further aspects of the invention, the method further comprises the step of: (g) trading a selected player for a new player. Trading a selected player for a new player comprises the steps of: i) deleting the electronic trading card identifying the player to be traded; ii) receiving the electronic trading card for the new player; iii) storing the electronic trading card for the new player on at least one of the member computers; and iv) receiving updated statistics for the personalized fantasy sports team based on the statistical information stored on the corresponding electronic trading cards. Step (g) may comprise trading the selected player for a new player on the personalized fantasy sports team of another fantasy sports league community member.

In accordance with still further aspects of the invention, the method further comprises the step of: (g) displaying video of players on the personalized fantasy sports team.

In accordance with other aspects of the invention, the computer implemented system comprises: a) an electronic trading card generator configured to generate a plurality of electronic trading cards, each of the electronic trading cards identifying a player and having statistical information about the player stored thereon; b) a registration module configured to register a plurality of users, each of the users being a member of the fantasy sports card community, each member of the fantasy sports card community being able to create a personalized fantasy sports team comprising a plurality of players identified by a plurality of electronic trading cards; c) a fantasy sports league database configured to store an identity of and statistical information corresponding to each of the players identified on the electronic trading cards; d) a fantasy sports team generator configured to facilitate creation and changing of the personalized fantasy sports team; e) an external interface for transmitting messages to and receiving messages from the community members of the fantasy sports card community.

### BRIEF DESCRIPTION OF THE DRAWINGS

These as well as other features of the present invention will become more apparent upon reference to the drawings wherein:

FIG. 1 is a block diagram of an exemplary configuration of the present invention;

FIG. 2 is a block diagram of the major components stored in memory of the server shown in FIG. 1;

FIG. 3 is a flow diagram illustrating exemplary logic performed by the server of FIG. 1 for creating and operating a fantasy sports card community in accordance with the present invention;

FIG. 4 is a flow diagram illustrating exemplary logic for creating and editing electronic trading cards in accordance with the present invention;

FIG. 5 is a flow diagram illustrating exemplary logic for creating a new electronic trading card;

FIG. 6 is a flow diagram illustrating exemplary logic for generating an electronic trading card;

FIG. 7 is a flow diagram illustrating exemplary logic for editing an existing electronic trading card;

FIG. 8 is a flow diagram illustrating exemplary logic implemented by a client computer shown in FIG. 1 for a member of the fantasy card community member to perform operations as a member of the community;

FIG. 9 is a flow chart illustrating exemplary logic for creating a personalized fantasy sports team in accordance with the present invention;

FIG. 10 is an exemplary user interface illustrating the major functions that can be invoked by a member of the fantasy sports card community;

FIG. 11 is an exemplary user interface screen for creating/viewing/editing electronic trading cards in accordance with the present invention;

FIG. 12 is an exemplary user interface screen for creating a new electronic trading card; and

FIG. 13 is an exemplary user interface screen for editing an existing electronic trading card.

### DETAILED DESCRIPTION OF THE INVENTION

The present invention provides a mechanism for a user to create an electronic community for a fantasy sports league. Pertinent information is stored on electronic trading cards.

U.S. patent application Ser. No. 09/718,298 titled “Method and Apparatus for Distributing and Trading Electronic Trading Cards,” filed on Nov. 21, 2000, the entire contents of which are incorporated herein by reference, discloses a system and method of collecting and trading electronic trading cards. That patent application discloses a mechanism for readily obtaining detailed written and pictorial information regarding various subjects and personalities of interest to the user. The information includes not only that available on a particular electronic trading card (ETC), but also links to various web sites having additional information related to the same player or sport. As such, by means of the disclosed invention an enthusiast can obtain an electronic portal to subject-related information related to a particular subject, personality, or sport. For the collector, the invention disclosed in U.S. patent application Ser. No. 09/718,298 allows for not only the collection of statistical information respecting individual players, but also video information that may depict various highlights of that player's professional career, and personal comments. To preserve collector value the ETCs may be stored in electronic form to preserve their condition, limited in distribution by readily measurable techniques, and encrypted to deter reproduction or otherwise insure authenticity.

The present invention allows users to become members of a fantasy sports league community. Each member can then create a fantasy sports league team. The team may include professional players or amateur players (e.g., college, high school, little league, etc.). In addition to creating a fantasy sports team and receiving statistics about the players on the team, the present invention allows community members to receive and disseminate additional related information. For example, members may receive video highlights of plays recently made by their team players. The member can then share that information with other members of the community, e.g., via a white board or e-mail. The community member may also be able to share some of the information with non-community members, e.g., via e-mail. In exemplary embodiments, if a community member sends an e-mail message to a non-community member, the e-mail message will contain an advertisement for the community that allows the non-community member the opportunity to register to become a community member.

The present invention automatically collects and disseminates information of interest without the need of a league administrator. Furthermore, the information received by a community member is limited to information of interest. Thus, a community member does not need to sift through unwanted information. Only information about his or her team players is forwarded without request. The present invention also allows community members to trade players without having to go through a league administrator.

The present invention transmits all of the relevant information to the participants for local storage at the client computers 22 of the participants. Thus, the amount of time required to view and interact with the desired information is minimized.

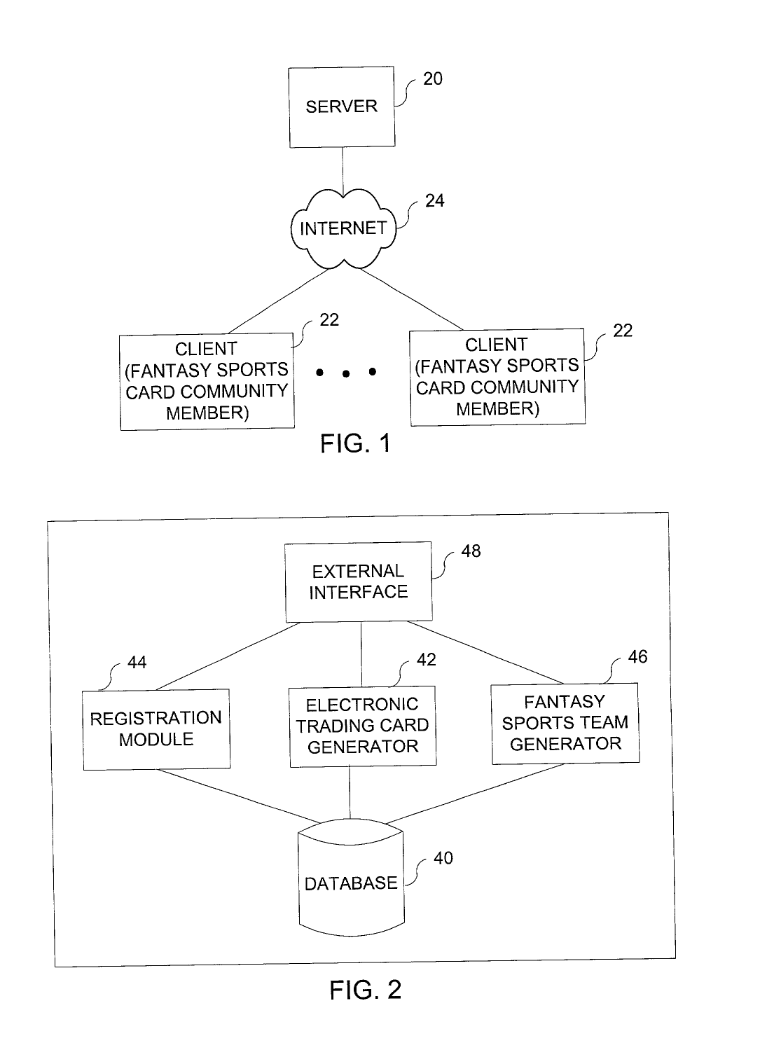

Referring now to the drawings wherein the showings are for purposes of illustrating preferred embodiments of the present invention only, and not for purposes of limiting the same, FIG. 1 is a block diagram illustrating an exemplary implementation formed in accordance with the present invention. Clients 22 sharing a common interest (e.g., a fantasy sports league) form a community. The community members communicate via a server 20. The present invention is specifically directed to a fantasy sports card community, e.g., fantasy football league, fantasy baseball league, fantasy soccer league, etc. It will be appreciated that the players in the fantasy sports league can be professional athletes, college athletes, high school athletes, little league players, etc.

The server 20 and client computers 22 of the present invention can be any one of various types of conventional computers, having a processing unit, a memory (including a permanent storage device), and a communication interface, as well as other conventional computer components (e.g., input device, such as keyboard and mouse, output device, such as display). In exemplary embodiments, the communication interface allows the server to communicate with the clients over a network 24, such as the Internet.

FIG. 2 is a block diagram illustrating the major components stored in memory on the server 20 of the present invention for allowing a fantasy sports league community to communicate. In the exemplary embodiment, members of the community can each create their own personalized fantasy sports team. There are electronic trading cards representing players that can be on a personalized fantasy sports team. In exemplary embodiments, a given player can be on a specified number of personalized fantasy sports teams. In exemplary embodiments, there are a number of instances of a given electronic trading card equal to the number of personalized fantasy sports teams on which the corresponding player can be a participant.

As shown in FIG. 2, a database 40 is used to store information. Exemplary data stored in the database 40 includes registration information for the members of the fantasy sports card community, information about the personalized fantasy sports teams for the various members and statistical information about the players.

An electronic trading card generator 42 is used to create the electronic trading cards. In exemplary embodiments (e.g., professional fantasy sports leagues), the provider of the server may generate the electronic trading cards. In other embodiments (e.g., for little league fantasy leagues), a program is provided that allows a community member (client) 22 to enter information to create an electronic trading card. The information stored on the electronic trading card can include textual information, graphical information and/or video information.

Registration module 44 allows users of client computers 22 to register as members of the fantasy sports card community. In exemplary embodiments, a category specific browser, such as the one disclosed in U.S. patent application Ser. No. 09/840,350, titled “Method and Apparatus for Viewing and Interacting with Category Specific Information,” filed on Apr. 23, 2001 the entire contents of which are incorporated herein by reference, is used for the fantasy sports card community member to enter and view information relating to fantasy sports. For example, using the category specific mini browser, the user views a list of available players and creates a personalized fantasy sports team by selecting players from the list of available players. The user can view electronic trading cards (i.e., information about players) in the category specific mini browser. The user can communicate with other members of the community, for example using a white board, a community chat or an instant messaging feature. The user can also communicate with non-members of the community, for example by sending e-mail that includes some of the data from an electronic trading card. The recipient of the e-mail can then register to become a member of the fantasy sports card community.

Fantasy sports team generator 46 provides members of the fantasy sports community with the list of available players and creates the member's personalized fantasy sports team based on the user's list of selected players. The fantasy sports team generator 46 also allows a member to change a personalized fantasy sports team by trading players. In exemplary embodiments, a player can only trade with another community member. In alternate embodiments, a member can trade for players that are in an available player pool stored on the server 20.

An external interface 48 is used to transmit messages (including electronic trading cards) from the server 20 to community members 22 and to receive messages sent to the server 20 by community members 22.

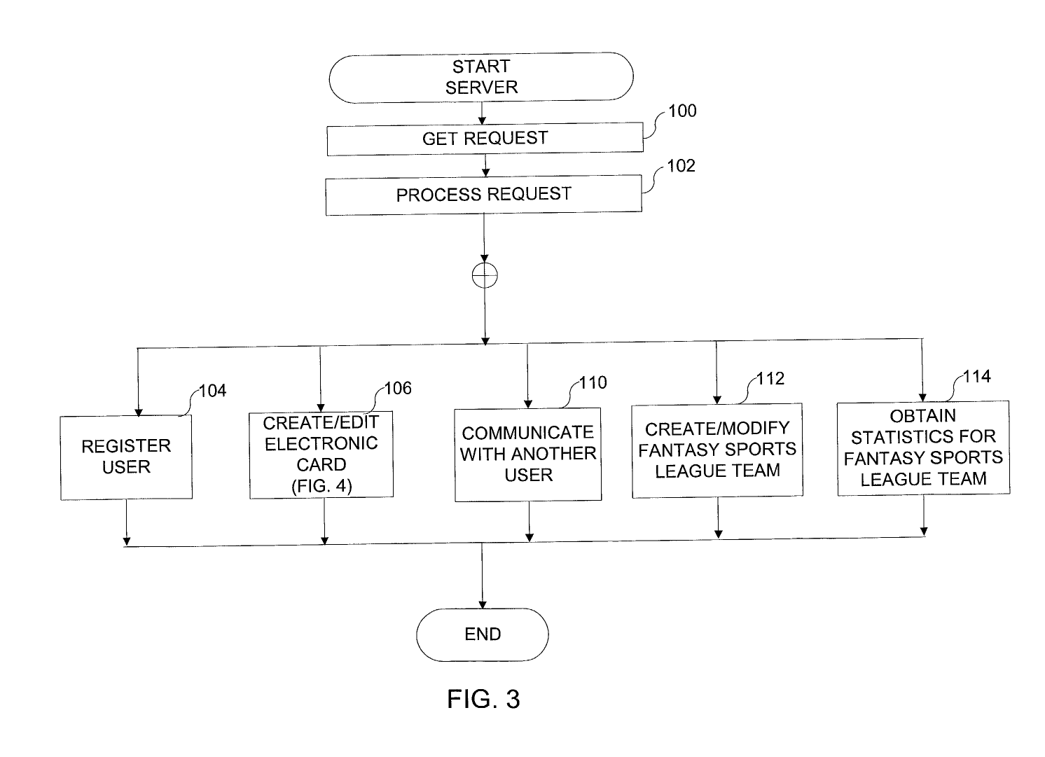

FIG. 3 is a flow diagram illustrating exemplary logic implemented by a server computer 20 for forming a community for fantasy sports leagues in accordance with the present invention. The logic of FIG. 3 moves from a start block to block 100 where the server gets a request. In exemplary embodiments, the request can be a request from a community member 22 or from a server operator. For example, a user may want to register to become a member of the community, to create a fantasy sports team, to trade a player or to communicate with another user. The operator of the server may create or modify electronic trading cards. In exemplary embodiments, members 22 may also create electronic trading cards.

After the request is received, the logic moves to block 102 where the request is processed as described next. If the request is a registration request, the registration module 44 registers the user. See block 104. The registration information is stored in the database 40. If the request is to create or edit an electronic trading card, the logic moves to block 106 where an electronic trading card is created or edited.

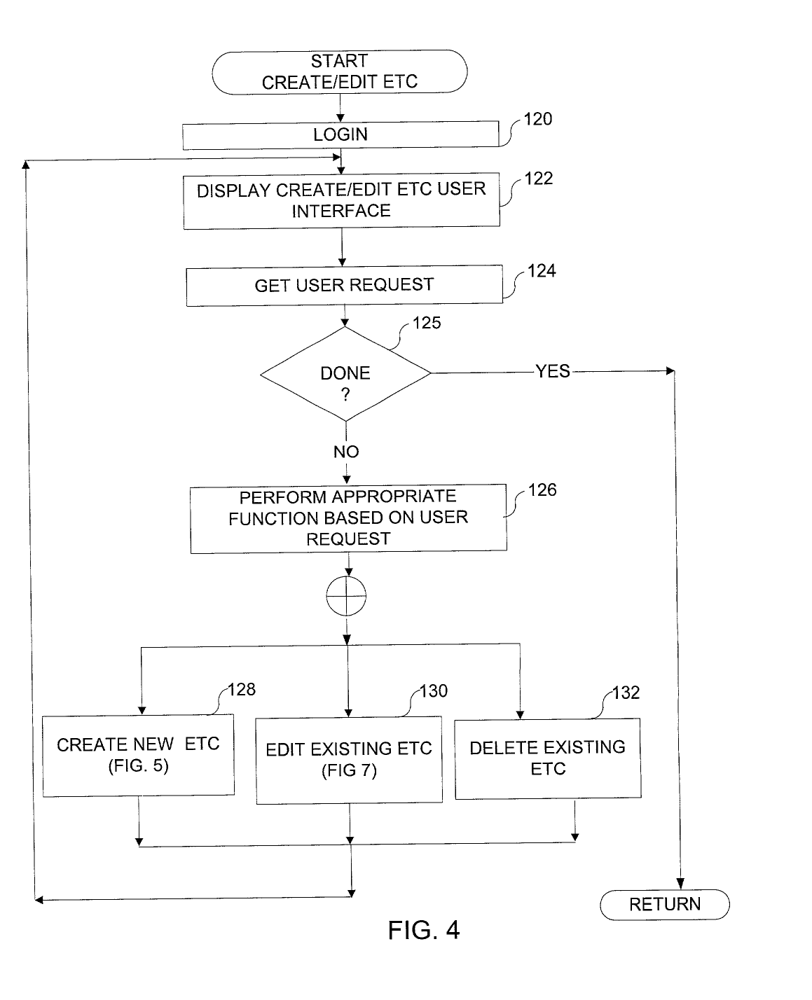

FIG. 4 is a flow diagram illustrating exemplary logic for creating or editing an electronic trading card in accordance with the present invention. The logic moves from a start block to block 120 where a user logs in. For example, the category specific mini browser for the fantasy sports league may have a function for creating electronic trading cards. The user activates (i.e., executes) the category specific mini browser program and navigates (e.g., through menus and/or buttons) to the create electronic trading card function. In alternative embodiments, the user may navigate to a website and request a login by entering a user identification and a password. A verification of the user identification/password is performed. If the information is valid, a secure login is performed. Upon a successful login, a user interface display provides the user with various available functions. See block 122.

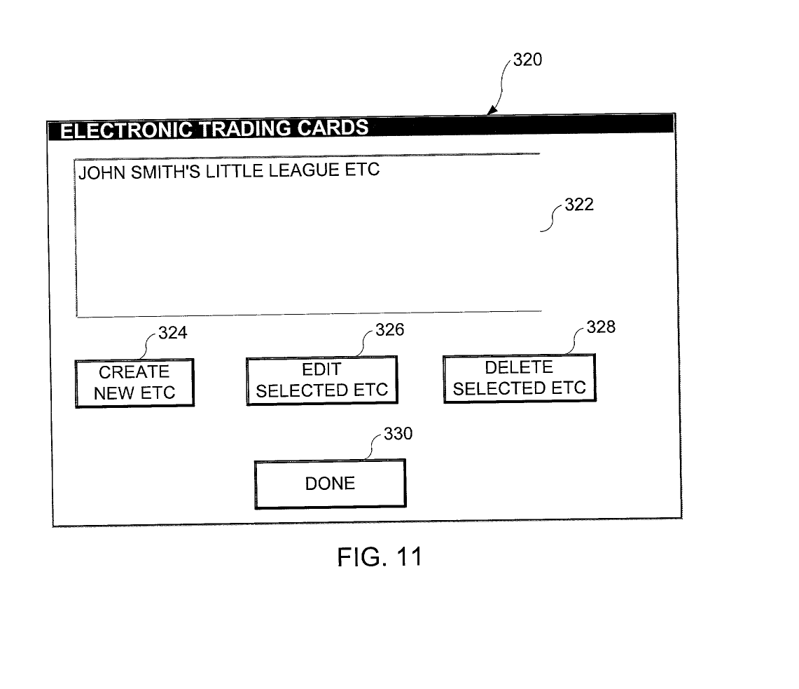

An exemplary user interface for creating/editing electronic trading cards 320 is shown in FIG. 11. The electronic trading card user interface 320 may include a list of all existing electronic trading cards for the user 322. In the exemplary electronic trading card user interface 320 shown in FIG. 11, the user may opt to: create a new electronic trading card by pressing a Create New ETC button 324, edit a selected electronic trading card by pressing an Edit Selected ETC button 326 or delete a selected electronic trading card by pressing a Delete Selected ETC button 328.

The logic of FIG. 4 proceeds to decision block 125 where a test is made to determine if the user is done creating/editing/deleting electronic trading cards. For example, a user may press a Done button (330 in FIG. 11) to indicate completion. Alternatively, the user may indicate completion by navigating to a different website or a different function in the category specific browser. If the user has finished creating/editing/deleting electronic trading cards, the logic of FIG. 4 ends and processing returns to FIG. 3.

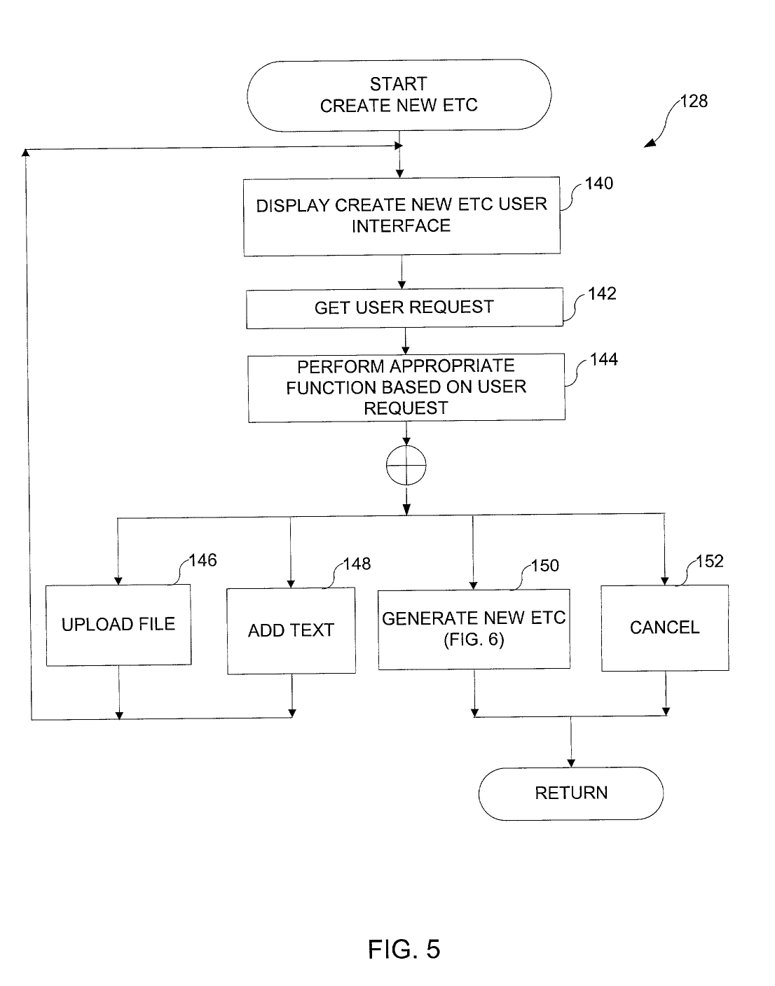

If, however, the user has not finished creating/editing/deleting individualized electronic trading cards, the logic moves to block 126 where the desired function is performed. If the desired function is to create a new electronic trading card, the logic moves to block 128 where a new electronic trading card is created as shown in FIG. 5 and described next.

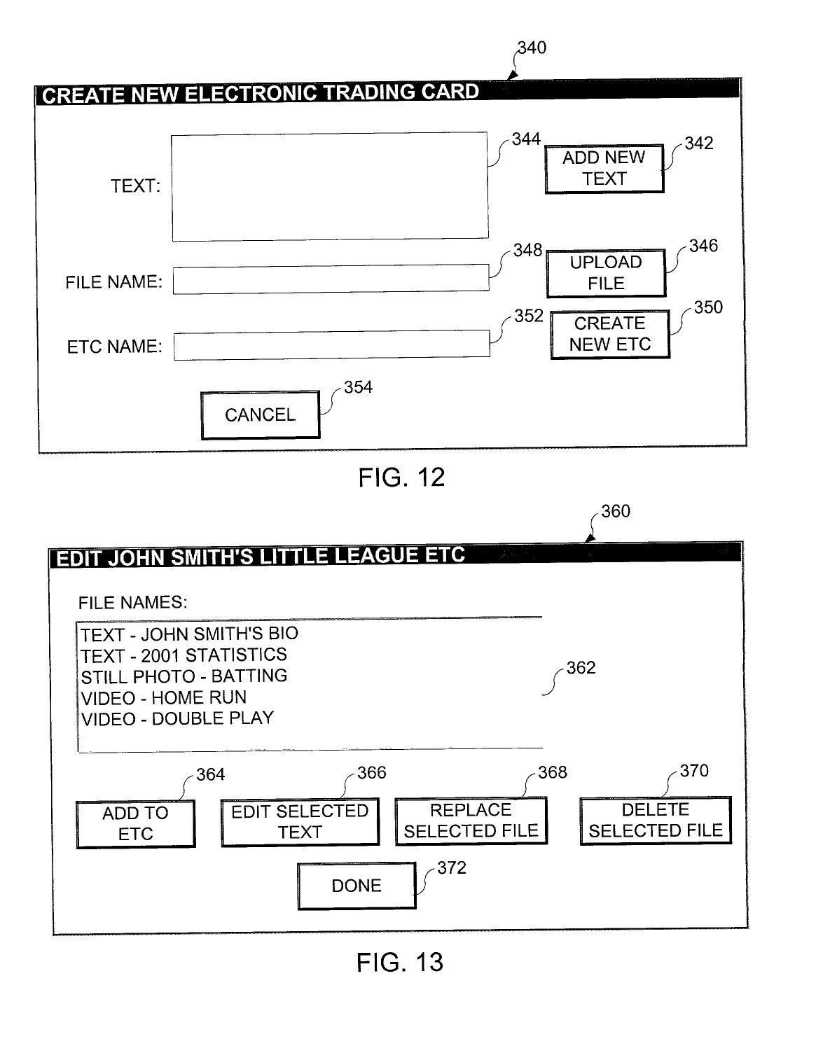

FIG. 5 is a flow diagram illustrating exemplary logic for creating a new electronic trading card. The logic moves from a start block to block 140 where a create new electronic trading card user interface is displayed. FIG. 12 illustrates an exemplary user interface for creating a new electronic trading card.

In exemplary embodiments, such as that shown in FIG. 12, the user can specify one or more files to be uploaded, for example by entering a filename in a filename field 348 and pressing an Upload File button 346. The file may be in various formats, e.g., text, graphics, audio, video. The user may also enter text in a text box 344 and have the text added to the electronic trading card by pressing an Add Text button 342. When the user has entered all of the information, a new electronic trading card can be generated by the user specifying a name in an ETC Name field 352 and pressing a Create New ETC button 350. The user may also cancel the creation process by pressing a Cancel button 354.

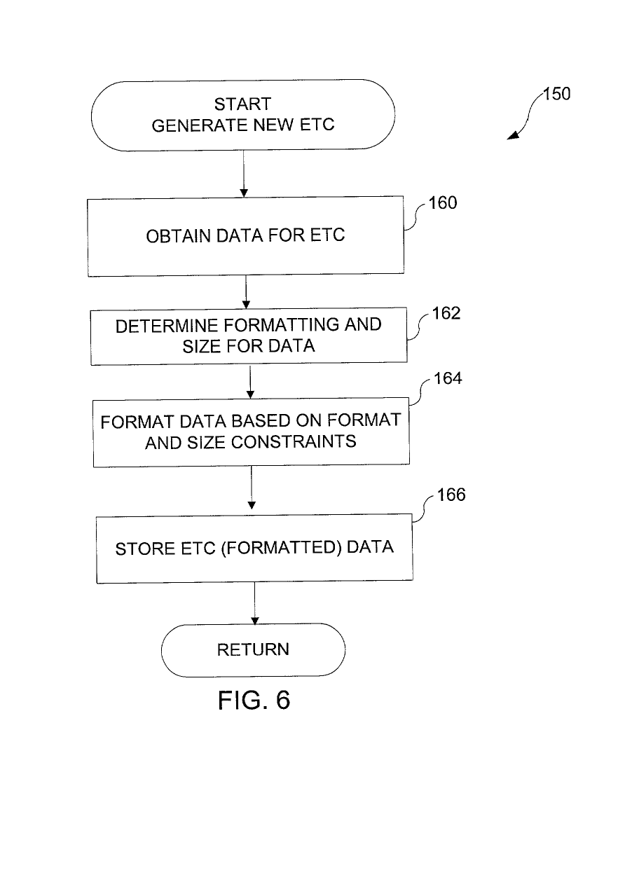

After the create new ETC user interface has been displayed, the logic of FIG. 5 moves to block 142 where user a user request is received. Next, the logic proceeds to block 144 where the request is processed. If the request is to upload a file, the logic moves to block 146 where the file is uploaded. The logic then returns to block 142 to get another request to be processed. If the request is to add text, the logic moves to block 148 where the text is added. For example, the text is transmitted from the client computer 22 displaying the create new ETC user interface to a server 20 that creates and stores the electronic trading cards. The logic then returns to block 140 to display the create new ETC user interface and to get another request to process. If the request is to create a new electronic trading card, the logic moves to block 150 where an electronic trading card is generated as shown in FIG. 6 and described below. After the electronic trading card is generated (block 150) or if the request is a cancel request (block 152), the logic of FIG. 5 ends and processing returns to FIG. 4.

FIG. 6 illustrates exemplary logic for generating the electronic trading card. The logic of FIG. 6 moves from a start block to block 160 where data for a the new ETC is obtained. In exemplary embodiments, the data is already at the server. For example, using a create new electronic trading card user interface such as that shown in FIG. 12, user specified text can be added and/or files can be uploaded. After specifying the desired text and/or files to upload, the user specifies a name to be used for the new electronic trading card. Alternatively, the data may reside at the client computer 22 until a request to generate the card is received. After the data for the electronic trading card has been obtained, the logic moves to block 162 where formatting and size is determined for the data. For example, the size of video to be used for a particular type of ETC (e.g., a professional athlete) may be set to a different size than for a different ETC (e.g., an amateur athlete). The format and size for a given type of data may vary based on the browser that is used to display the information. U.S. patent application Ser. No. 09/840,350 discloses a category specific mini browser suitable for viewing electronic trading cards created in accordance with the present invention. After the data is formatted, the logic moves to block 166 where the data for the new electronic trading card is stored. Various methods of storage may be employed, for example using a relational database. The logic of FIG. 6 then ends, and processing returns to FIG. 4.

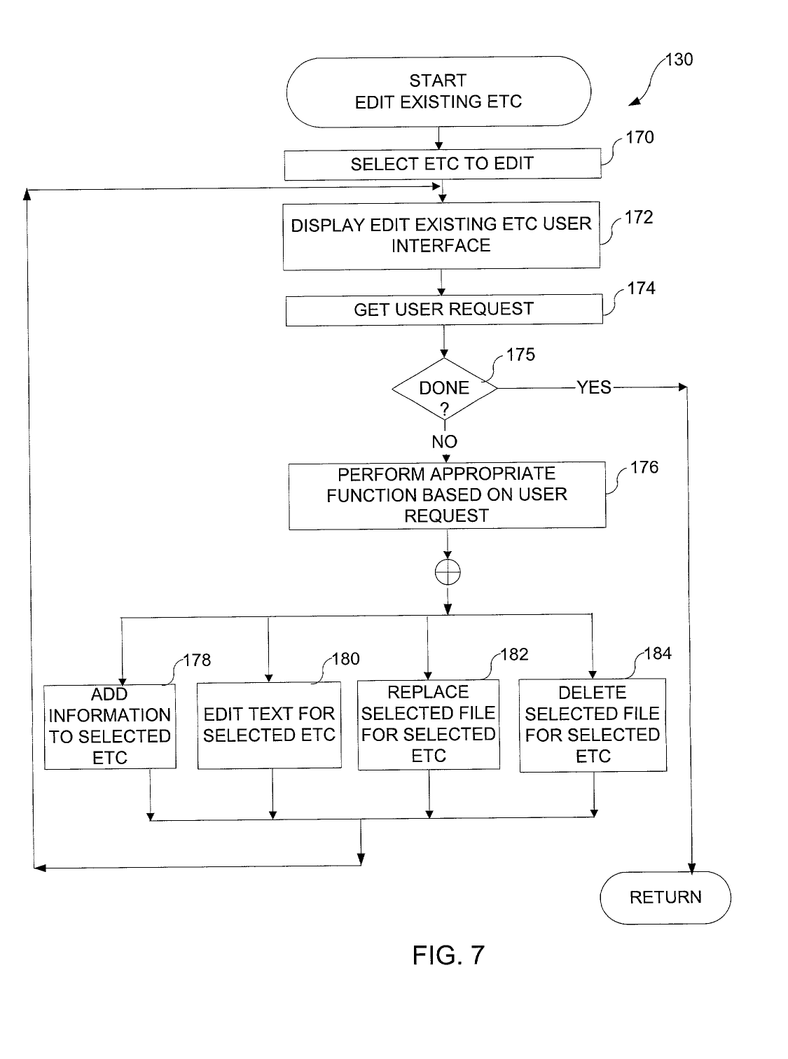

Returning to FIG. 4, if the user wishes to edit an existing electronic trading card, the logic moves to block 130 where the existing card is edited. FIG. 7 illustrates exemplary logic for editing an existing electronic trading card.

The logic of FIG. 7 moves from a start block to block 170 where an existing electronic trading card is selected. Next, the logic moves to block 172 where a user interface displaying editing options is provided. In exemplary embodiments, new information can be uploaded to be added to the existing information and/or to replace existing information. Existing information may also be deleted. FIG. 13 illustrates an exemplary user interface for editing an ETC in accordance with the present invention.

In the exemplary edit electronic trading card user interface 360 shown in FIG. 13, the user selected an electronic trading card (John Smith's Little League ETC from FIG. 11) and selected an edit function (e.g., by pressing an Edit Selected ETC button 326). The edit ETC user interface 360 shown in FIG. 13 includes a list of files 362 included in the ETC being edited. The user can add information to the ETC, for example by pressing an Add To ETC button 364. In exemplary embodiments, the add to ETC function displays a user interface that allows the user to enter text and/or files to be uploaded. The user can also edit text previously entered by pressing an Edit Text button 366. In exemplary embodiments, selecting an edit text function, downloads the existing text to the user to be edited. The user may also replace (i.e., edit) selected files by pressing a Replace Selected File button 368. This causes the existing file to be deleted and replaced by a new file downloaded by the user. The user may also delete one or more files by pressing a Delete Selected File button 370.

The logic of FIG. 7 proceeds to block 174 where a user request is obtained. Next, the logic moves to decision block 175 where a test is made to determine if editing the ETC is complete. For example, the user indicates completion of editing by pressing a Done button (372 in FIG. 13). If the user has finished editing the selected ETC (yes in decision block 175), the logic of FIG. 7 ends and processing returns to FIG. 4.

If, however, the user has not finished editing the ETC, the logic moves to block 176 where an appropriate function is performed based on the user request. If the user opts to add information to an existing ETC, the logic moves to block 178 where information is added, for example by the client computer 22 uploading text and/or files to the server computer 20. If the user wishes to edit text, the logic moves to block 180 where text is edited for the selected ETC. For example, the current text for the ETC is downloaded from the server 20 to the client computer 22 for editing. Once the text is edited, the revised text is uploaded from the client computer 22 to the server 20. If the user wishes to replace selected files for the selected ETC, the logic moves to block 182 where selected files for the selected ETC are replaced. If the user wishes to delete selected files, the logic moves to block 184 where selected files for the selected ETC are deleted. After the appropriate function is performed (e.g., adding information in block 178, editing text in block 180, replacing selected files in block 182, or deleting selected files in block 184), the logic returns to block 172 where the user interface is displayed and another user request is obtained and processed. The logic of blocks 172-184 is repeated until it is determined in decision block 175 that editing is done. When editing is done, the logic of FIG. 7 ends and processing returns to FIG. 4.

Returning to FIG. 4, if the request is to delete an existing ETC, the logic moves to block 132 where an existing ETC is deleted. Deleting an existing ETC includes selecting an ETC to delete and updating the database to delete the ETC. In exemplary embodiments, the ETC is marked as deleted but is not actually deleted from the database. Once an ETC has been deleted, it does not show up in the list of existing ETCs. After the requested function has been performed (e.g., creating a new ETC in block 128, editing an existing ETC in block 130, or deleting an existing ETC in block 132), the logic returns to block 122 to display the create/edit ETC user interface and to receive and process another user request. The logic of blocks 124-132 is repeated until there are no more user requests to process, for example due to the user navigating to another website. When there are no more requests to process, the logic of FIG. 4 ends and processing returns to FIG. 3.

Returning to FIG. 3, if the user wishes to communicate with another user, the logic moves to block 110 where the community member can communicate with another community member. In exemplary embodiments, members of the community can communicate using a white board. For example, a video clip may be played and users can write comments on the white board (e.g., annotate graphics). Members can also send messages via e-mail. In exemplary embodiments, e-mail messages may also be sent to users who are not members of the community.

If the user wishes to create or modify a personalized fantasy sports team, the logic moves to block 112. In exemplary embodiments, if the user wishes to create a team, a list of available players is displayed. The list of available players can be determined based on the available instances of the electronic trading cards. In exemplary embodiments, the number of instances varies among the available players. When a player is selected for a personalized fantasy sports team, one of the available instances of the electronic trading card is sent to the member creating the personalized fantasy sports team. Once all instances of an electronic trading card have been distributed, the player is no longer available. Thus, the fewer instances of an electronic trading card, the more valuable the player. For example, if there are 1,000 instances of a particular player and 2,000 instances of two other players, the one player having only 1,000 instances may be traded for the two players that each have 2,000 instances.

If a community member 22 wishes to change his personalized fantasy sports team, he may trade players. In exemplary embodiments, a player can only trade with other members. In alternative embodiments, a user can only trade for players in an available pool on the server. In still other embodiments, a player may trade for players on another members team, as well as players in the available pool on the server.

If statistics are desired, the logic moves to block 114 where the server sends statistics to the member computer 22. In exemplary embodiments, statistics are updated regularly (e.g., every week) and automatically sent to all of the members having a personalized fantasy sports team.

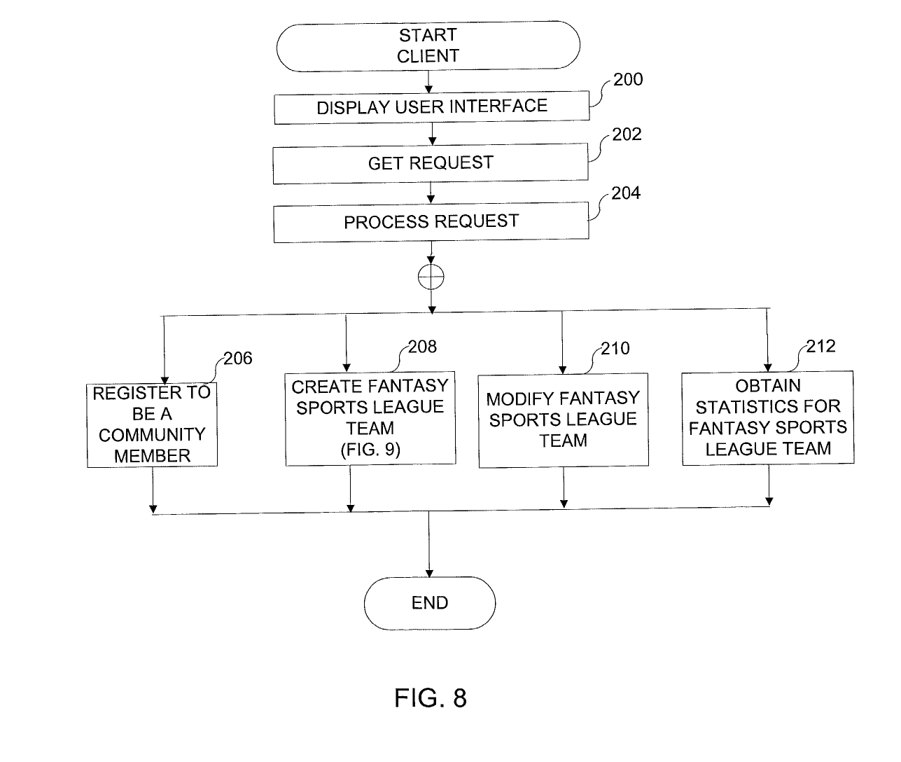

FIG. 8 is a flow diagram illustrating exemplary logic performed by a client computer 22 in accordance with the present invention. The logic moves from a start block to block 200 where a user interface is displayed. For example, the user launches a category specific browser for fantasy sports card communities, such as the category specific browser disclosed in U.S. patent application Ser. No. 09/840,350.

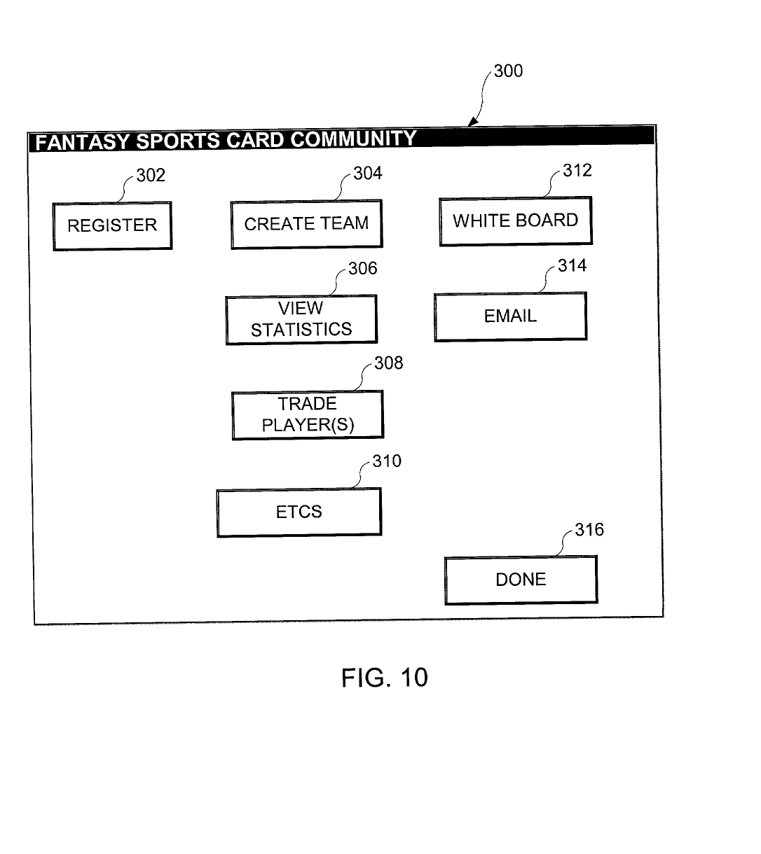

The category specific browser displays a user interface that allows a user to easily perform various functions within the fantasy sports card community. For example, as shown in the exemplary user interface of FIG. 10, the user can: register as a member of the fantasy sports card community by pressing a Register button 302; create a personalized fantasy sports team by pressing a Create Team button 304, trade players to change the fantasy sports team by pressing a Trade Player(s) button 308; view statistics by pressing a View Statistics button 306; create or edit electronic trading cards by pressing an ETCS button 310; communicate with other users, for example via white board by pressing a White Board button 312 or an E-Mail button 314. It will be appreciated that additional functions may be available in various embodiments of the invention. For example, the user may be able to create and edit electronic trading cards as described above.

After displaying the user interface, the logic of FIG. 8 moves to block 202 to receive a user request. In exemplary embodiments, the user must first register to become a community member. Once the user is a registered member of the community, the user can perform other functions, such as those shown in FIG. 10. Next, the logic moves to block 204 where the request is processed. If the user requests registration as a community member, the logic moves to block 206 where the user is registered. The registration process includes requesting information from the user (e.g., name, e-mail address, etc.) and forwarding the information to the server 20 to complete the registration process. In exemplary embodiments, demographic information may be requested. Exemplary embodiments may include advertisements based on the user's interest (e.g., sports in general, and specifically the sport that is the subject of the fantasy sports league) and specific information, such as age and/or geographic location of the user. The users interactions may also be tracked, for example for statistical and marketing purposes.

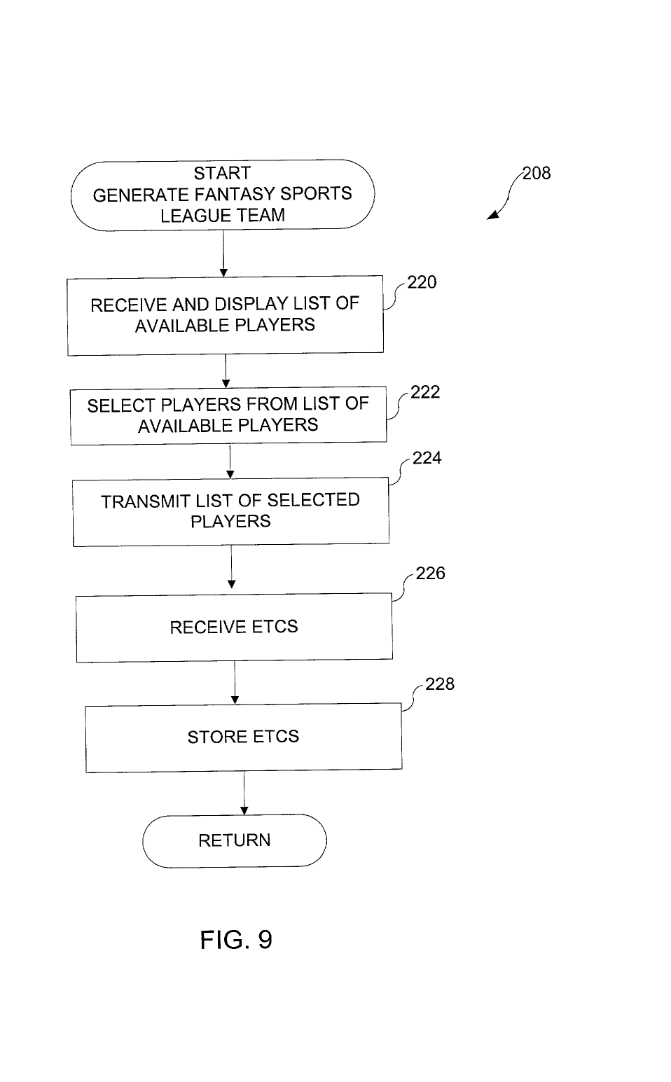

If the user wishes to create a personalized fantasy sports team, the logic moves to block 208 to create the fantasy sports team. Exemplary logic for creating a fantasy sports team is illustrated in FIG. 9 and described next.

The logic of FIG. 9 moves from a start block to block 220 where a list of available players is received and displayed. The user selects players from the list of available players in block 222. The list of available players is transmitted to the server 20 in block 224. The server 20 creates the personalized fantasy sports team based on the selected list of players received from the member of the fantasy sports card community. Next, the logic moves to block 226 where the user receives ETCs for the players on the personalized fantasy sports team. The received ETCs are then stored. See block 228. It will be appreciated that in exemplary embodiments, statistics for the team are received after the team is created. The logic of FIG. 12 then ends.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

What is claimed is:

1. An entertainment method implemented through the use of a server and a plurality of member computers, the server being configured to create a fantasy sports card community having a plurality of fantasy sports card community members, each of the community members being able to create a personalized fantasy sports team having a plurality of players, change the sports team by trading players, obtain statistics for the players on the sports team and communicate with other fantasy sports card community members, the method comprising the steps of:
a) creating a plurality of electronic trading cards, each of the electronic trading cards identifying a player and including statistical information about the player stored thereon;
b) creating a fantasy sports league database by storing the identity and statistical information corresponding to each of the players identified on the electronic trading cards;
c) registering the community members;
d) generating a list of available players from the electronic trading cards;
e) transmitting the list of available players to at least one of the community members to facilitate the creation of the personalized fantasy sports team;
f) receiving a list of selected players from the at least one of the fantasy sports card community members;
g) creating the personalized fantasy sports team for the at least one of the community members based on the list of selected players; and
h) transmitting the electronic trading cards corresponding to the list of selected players to the at least one of the community members.

2. The method of claim 1, wherein steps (d)-(h) are repeated for each of the community members registered in step (c).

3. The method of claim 1, wherein step (a) comprises:
i) determining a number of personalized fantasy sports teams on which each player can be a participant; and
ii) creating a volume of each electronic trading card corresponding to the number of personalized fantasy sports teams on which each player can be a participant.

4. The method of claim 1, further comprising the steps of:
i) calculating statistics for the personalized fantasy sports team based on the statistical information stored on the electronic trading cards corresponding to the participants on the personalized fantasy sports team; and
j) transmitting the statistics for the personalized fantasy sports team to at least one of the member computers.

5. The method of claim 1, further comprising the steps of:
i) changing the personalized fantasy sports team by replacing at least one player on the personalized fantasy sports team with at least one different player;
j) transmitting a delete command including instructions for deleting the electronic trading cards corresponding to the at least one player on the personalized fantasy sports team that is being replaced; and
k) transmitting the electronic trading card corresponding to the at least one different player replacing the at least one player being deleted to at least one of the member computers.

6. The method of claim 5, further comprising:
l) calculating statistics for the changed personalized fantasy sports team based on the statistical information stored on the electronic trading cards corresponding to the changed personalized fantasy sports team; and
m) transmitting the statistics for the changed personalized fantasy sports team.

7. The method of claim 5, wherein step (i) comprises selecting the at least one different player from at least one other fantasy sports card community member.

8. An entertainment method implemented through the use of a server and a plurality of member computers, the member computers being operative to register a user as a fantasy sports card community member, select a plurality of players to create a personalized fantasy sports team, selectively change the personalized fantasy sports team by trading players, obtain statistics for the personalized fantasy sports team and communicate with other fantasy sports card community members, the method comprising the steps of:
a) registering the user as one of the fantasy sports card community members through the use of at least one of the member computers;
b) receiving a list of available players from the server;
c) creating a list of selected players from the list of available players;
d) transmitting the list of selected players to the server for creating the personalized fantasy sports team;
e) receiving electronic trading cards corresponding to the list of selected players, each of the electronic trading cards identifying a player and including statistical information corresponding to the identified player; and
f) storing the electronic trading cards on at least one of the member computers.

9. The method of claim 8, further comprising the step of:
(g) receiving statistics for the personalized fantasy sports team based on the statistical information stored on the corresponding electronic trading cards.

10. The method of claim 8, further comprising the steps of:
g) displaying a communication interface on the member computer to allow a first fantasy sports card community member to interactively communicate with at least one other fantasy sports card community member;
h) accepting information from the first fantasy sports card community member via the communication interface; and
i) forwarding the information from the first fantasy sports card community member to the at least one other fantasy sports card community member.

11. The method of claim 10, wherein step (g) comprises displaying a white board as the communication interface.

12. The method of claim 8, wherein steps (a)-(f)are implemented through the use of a browser.

13. The method of claim 12, wherein step (a)-(f) are implemented through the use of a category specific mini browser.

14. The method of claim 8, further comprising the step of:
(g) receiving updated statistics for each player identified on the electronic trading cards stored on the at least one of the member computers.

15. The method of claim 8, further comprising the step of:
(g) trading a selected player for a new player.

16. The method of claim 15, wherein step (g) comprises the steps of:
i) deleting the electronic trading card identifying the player to be traded;
ii) receiving the electronic trading card for the new player;
iii) storing the electronic trading card for the new player on the at least one of the member computers; and
iv) receiving updated statistics for the personalized fantasy sports team based on the statistical information stored on the corresponding electronic trading cards.

17. The method of claim 16, wherein step (g) comprises trading the selected player for a new player on the personalized fantasy sports team of another fantasy sports league community member.

18. The method of claim 8, further comprising the step of:
(g) displaying video of players on the personalized fantasy sports team.

19. A computer implemented system for creating a fantasy sports card community having a plurality of fantasy sports card community members, each of the community members being able to create a personalized fantasy sports team having a plurality of players, change the personalized fantasy sports team by trading players, obtain statistics for the personalized fantasy sports team and communicate with other fantasy sports card community members, the system comprising:
a) an electronic trading card generator configured to generate a plurality of electronic trading cards, each of the electronic trading cards identifying a player and having statistical information about the player stored thereon;
b) a registration module configured to register a plurality of users, each of the users being a member of the fantasy sports card community, each member of the fantasy sports card community being able to create a personalized fantasy sports team comprising a plurality of players identified by a plurality of electronic trading cards;
c) a fantasy sports league database configured to store an identity of and statistical information corresponding to each of the players identified on the electronic trading cards;
d) a fantasy sports team generator configured to facilitate creation and changing of the personalized fantasy sports team;
e) an external interface for transmitting messages to and receiving messages from the community members of the fantasy sports card community.
